(19) United States
(12) Patent Application Publication
(10) Pub. No.: US 2012/0249297 A1
(43) Pub. Date: Oct. 4, 2012

(54) Consent Biometrics

(76) Inventors: Eliza Yingzi Du, Indianapolis, IN (US); Kai Yang, Indianapolis, IN (US)

(21) Appl. No.: 13/396,551

(22) Filed: Feb. 14, 2012

Related U.S. Application Data
(60) Provisional application No. 61/443,431, filed on Feb. 16, 2011.

(51) Int. Cl. G06F 7/04

(52) U.S. Cl. 340/5.82

(57) ABSTRACT

A system with its methods of detecting whether users are willing to access the biometric systems has been developed that includes acquiring the signal of an anatomical feature having a biometric feature, acquiring a dynamic feature for willingness test with/without biometric feature, isolating a region of the signal having the biometric feature, extracting feature descriptors from the region to identify a user, extracting a unique user consent signature from the dynamic feature for willingness test, storing the of feature descriptors and willingness signature into an electronic database and matching the feature descriptors and consent signatures with the ones stored in the electronic database during registration. Two types of consent biometrics schemes with two authentication example designs are developed.

### PRIORITY CLAIM

This application claims priority from U.S. Provisional Application No. 61/297,543, which is entitled “Consent Biometrics” and was filed on Feb. 16, 2011.

### TECHNICAL FIELD

The system and method described below relate to the identification of a person with reference to external biological and/or behavior characteristics of the person.

### BACKGROUND

Systems for identifying persons through intrinsic human traits have been developed. These systems operate by taking data of a biological and/or behavior trait of a person and comparing information stored in the database corresponding to the acquired trait for a particular person. Since these systems take the measure, or “metric” of a portion of a person or other biological being from the data, they are commonly referred to as “biometric” systems. When the information stored in the image has a high degree of correlation to the relevant data previously obtained for a particular person's trait, positive identification of the person may be obtained. These biometric systems obtain and compare data of physical features, such as fingerprints, voice, facial characteristics, iris patterns, hand geometry, retina patterns, and hand/palm vein structure. Different traits impose different constraints on the identification processes of these systems. For example, iris recognition systems require the subject to cooperate with an imaging acquisition device directly for the purpose of obtaining iris data from the object. Similarly, retina pattern identification systems require the subject to allow an imaging system to scan the retinal pattern within one's eye for an image capture of the pattern that identifies a person. Facial feature recognition systems, however, do not require direct contact with a person and these biometric systems are capable of capturing identification data without the cooperation of the person to be identified. The liveness test is another constraint and was developed to ensure the biometric features are from a live person to prevent replaying of biometric features and/or using fake biometric features to gain access.

While current biometric systems are already used in modern society, they also have safety and privacy drawbacks. One such drawback is the danger that a system guarded with biometrics can be accessed without the willingness of the true biometric owner. More specifically, the biometrics guarded system can be assessed when users are under threat, reluctant or even unconscious states. For example, a hypothetical person Alice may have an image of her fingerprint registered with a current biometric identification system. If Bob is a malicious person, he could intimidate or even knock Alice out of conscious to use her fingerprint patterns to get into the biometrics guarded system without Alice's consent.

The above scenario presents grave problems for Alice. The attacker can simply intimidate Alice to force her to access the system, or even worse, the attacker can harm Alice to get her external biometric traits and present them to the system. Thus, in current biometric systems, it is practically impossible to tell the difference between Alice and Bob, if Bob is able to force Alice to access the system for him. Currently there is no commercialized system that can detect if the user willingly presents the biometric for access. Biometric authentication devices with a method willingness detection of people would greatly enhance security and reduce crime.

### SUMMARY

Consent biometric systems with methods of detecting whether users are willing to access the biometric systems have been developed that include acquiring the signal of an anatomical feature having a biometric feature, acquiring a dynamic feature for a willingness test, isolating a region of the signal having the biometric feature, extracting feature information from the region to identify a user, extracting a unique user consent signature from the dynamic feature for willingness test, and storing the feature information and willingness signature into an electronic database.

In another embodiment, a method for authenticating a biometric feature signal of an anatomical feature includes acquiring the signal of an anatomical feature having a biometric feature, isolating a region of signal having the biometric feature, extracting feature descriptors from the region to identify a user, extracting a unique user consent signature from the dynamic feature for a willingness test, and matching the feature information and consent signature with the ones stored into an electronic database during registration.

An example system that uses the face for authenticating a biometric feature in an image of an anatomical feature includes a digital video camera configured to acquire an image of an anatomical feature having a biometric feature of a subject, an electronic database for storage of face features and consent signatures and a digital image processor. The digital image processor is configured to isolate a region of the image having the face features, extract face features from the region to identify a user, extract a unique user consent signature from the dynamic feature for willingness test, retrieve an arrangement of features and a consent signature for the willingness test from the electronic database, compare the extracted feature templates to the enrolled arrangement of feature descriptors, compare the extracted consent signature to the retrieved consent signature and to generate a signal indicating whether the extracted features match to the enrolled features and whether the extracted consent signature matches to the enrolled consent signature. The system combines the face template and facial expression sequence for human verification/identification. Face expression signature is used to extract the consent signature.

An example system that uses the iris for authenticating a biometric feature in an image of an anatomical feature includes a digital video camera configured to acquire an image of an anatomical feature having a biometric feature of a subject, an electronic database for storage of feature descriptors and consent signature for the biometric feature, and a digital image processor. The digital image processor is configured to isolate a region of the image having the biometric feature, extract feature descriptors from the region to identify a user, extract a unique user consent signature from the dynamic feature for willingness test, retrieve an arrangement of features for a biometric feature and a consent signature for willingness test from the electronic database, compare the extracted features to the retrieved arrangement of features, compare the extracted consent signature to the retrieved consent signature and to generate a signal indicating whether the extracted features match to the retrieved features and whether the consent signatures match. The system combines the iris template and eye movement sequence for human verification/identification. Eye movement sequence is used to extract the consent signature

### BRIEF DESCRIPTION OF THE DRAWINGS

FIG. 1 is a flow diagram of consent biometrics system for enrollment and authenticating

FIG. 2 is a flow diagram of a process for the first type of scheme of consent biometric system

FIG. 3 is a flow diagram of a process for the second type of scheme of consent biometric system

FIG. 4 is a flow diagram of an authentication example design of consent biometric system using face

FIG. 5 depicts a frontal image of a human eye and identifies the relevant parts of the image;

FIG. 6 is a flow diagram of an authentication example design of consent biometric system using iris

### DETAILED DESCRIPTION

For the purposes of promoting an understanding of the principles of the embodiments disclosed herein, reference will now be made to the drawings and descriptions in the following written specification. It is understood that no limitation to the scope of the subject matter is thereby intended. It is further understood that the present disclosure includes any alterations and modifications to the illustrated embodiments and includes further applications of the principles of the disclosed embodiments as would normally occur to one skilled in the art to which this disclosure pertains.

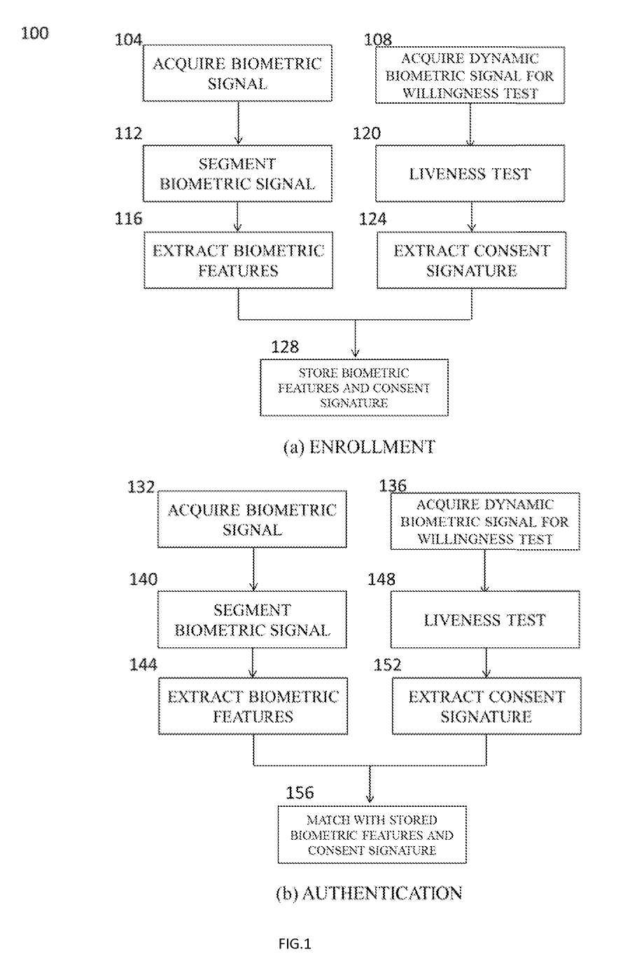

A method 100 for registering and matching the input biometric signal of the consent biometric system is depicted in FIG. 1. During enrollment (100(a)), the method begins by acquiring a biometric signal for biometric trait comparison (block 104) and a dynamic biometric signal for willingness test (block 108). The region of the signal containing the biometric traits of interest is segmented from the signal acquired from 104 (block 112). The segmented signal is processed by block 116 and a feature descriptor is calculated and generated (block 116).

At the same time, the dynamic biometric signal acquired from 108 is processed by block 120 to test whether the biometric trait is live. The method continues by extracting a consent signature from the live dynamic sequential signal by block 124. This requires the biometric sensor to have the capability to acquire dynamic sequential data (such as videos). Taking fingerprint recognition as an example, the user applies different strokes to operate the fingerprint acquisition device. The device will recognize and record the stroke patterns to generate a signature. For iris recognition, the consent signature can be a sequence of eye movement patterns. For face recognition, the consent signatures can be the head movement sequence, or facial expression sequence.

The method 100(a) continues by registering the generated feature templates and consent signature in electronic database (block 128).

During authentication (100(b)), the method begins by acquiring a biometric signal for biometric trait comparison (block 132) and a dynamic biometric signal for willingness test (block 136). The region of the signal containing the biometric traits of interest is segmented from the signal acquired from 132 (block 140). The segmented signal is processed by block 144 and a feature template is calculated and generated.

At the same time, the dynamic biometric signal acquired from 136 is processed by block 148 to test whether the biometric trait is live. The method continues by extracting a consent signature from the live dynamic sequential signal by block 152.

The method 100(b) continues by matching the generated feature template and consent signature with the ones retrieved from database. (block 156) The matching results from block 156 are fused to generate the final decision. Access is authorized only if both of the biometric feature descriptors and consent signatures are matched.

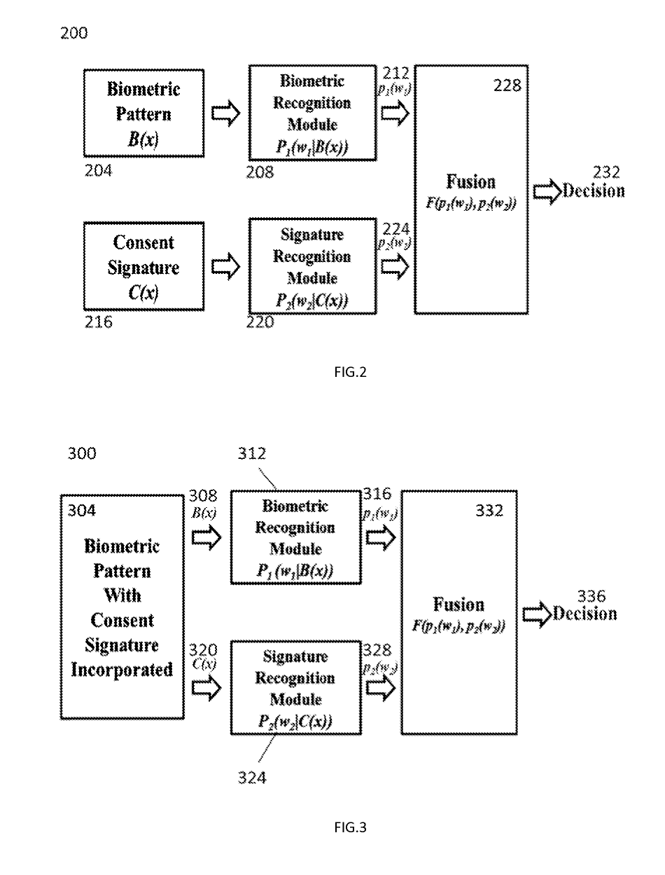

One type of scheme named Combinational Consent Biometric System (200) is depicted in FIG. 2. The biometric pattern B(x) (204) and consent signatures C(x) (216) are acquired separately from user x. B(x) will go through biometric recognition module (208) with a recognition function P₁(w₁|B(x)) and output a probability p₁(w₁) (212). The consent signature will be transmitted into the signature recognition module (220) with a recognition function P₂(w₂|C(x)) for processing, feature extraction and signature matching and a result p₂(w₂) (224) is generated. Finally, the two outputs are combined by block 228 to give the final authentication result (232). This type of system may need two kinds of sensors to acquire data. However traditional biometric systems can be used to obtain, process, extract and match biometric features.

The other type of scheme named Incorporating Consent Biometric System (300) is depicted in FIG. 3. The consent signature is acquired simultaneously with the biometrics data (block 304). In other words, the biometric data incorporates the consent signature. This requires the biometric sensor to have the capability to acquire sequential data (such as videos). In this scheme, the consent signature includes both active and passive physiological/behavior information. Biometric pattern B(x) (308) and consent signature C(x) (320) are extracted from the incorporated input.

In this scheme, the biometric pattern B(x) is processed through the biometric recognition module (block 312) with function P₁(w₁|B(x)) and compared with the entire database. The user selects his/her own dynamic pattern as the consent signature C(x) during the biometric registration process (block 128). During matching stage (block 132), the dynamic biometric data would be acquired by the biometric system. The consent signature will be extracted as well as the biometric features and processed through the consent signature module (block 324) with function P₂(w₂|C(x)). Only if the biometric data and consent signature are matched and proved to be from an eligible user, the access is authorized.

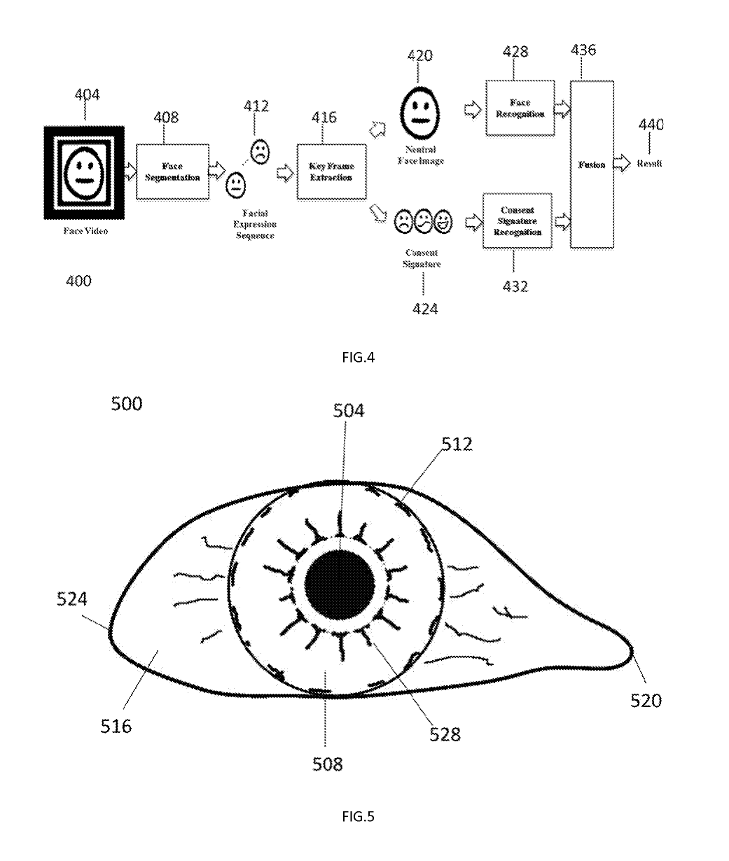

An example authentication design 400 of method 200 using face is depicted in FIG. 4. The example design begins by acquiring a video sequence of subject's face with multiple facial expressions (block 404). The video acquisition may be performed with a digital camera having an adequate resolution for imaging features within the face area of the subject. The facial expression sequence is used to test liveness of biometric traits.

The example design 400 continues by segmenting the face area from each frame of the acquired face sequence 412 (block 408). Skin color can be used to determine the interest region. The location, shape and size information is considered to further eliminate the non-face parts. The face area is cropped out, normalized and enhanced to reduce lighting variation. Any other effective face segmentation method can be applied in 408.

Neutral face image (420), i.e., face frame without facial expressions is then extracted from the video sequence by block 416. At the same time, a facial expression sequence (424) is extracted from the video to generate the consent signature by 416. Each segmented face frame is normalized and smoothed by a Gaussian filter and compare to an average neutral face frame to determine whether it is an element of 424. The corresponding facial expression is detected and extracted by 416 and a consent signature is generated and encoded from 424.

The design continues by processing the generated 420 and 424. Face template is calculated and generated by block 428 for 420 and by block 432 for 424 respectively. A face recognition method is applied to block 428. A classifier was trained by facial expression images and applied to block 432 to classify each face expression frame in 424. The generated feature descriptors generated from 428 and 432 are compared to the corresponding ones stored in electronic database during registration belonging to the identity the subject claims to be.

The authentication example design was then followed by fusing the comparison results from 428 and 432 to generate a final result 440 (block 436). There are four scenarios possible during the process of 436: both 428 and 432 are matched, 428 is matched but 432 is not, 432 is matched but 428 is not, neither of 428 and 432 are matched. Only the first scenario is considered to be a valid access.

An illustration of a human eye is shown in FIG. 5. The eye 500 includes a pupil 504 surrounded by an iris 508. A limbic boundary 512 separates the iris 508 from the sclera region 516. A medial point 520 identifies the area where a tear duct is typically located and the lateral point 524 identifies an outside edge of the image. Within the iris 508 are textured patterns 528. These patterns have been determined to be sufficiently unique that may be used to identify a subject.

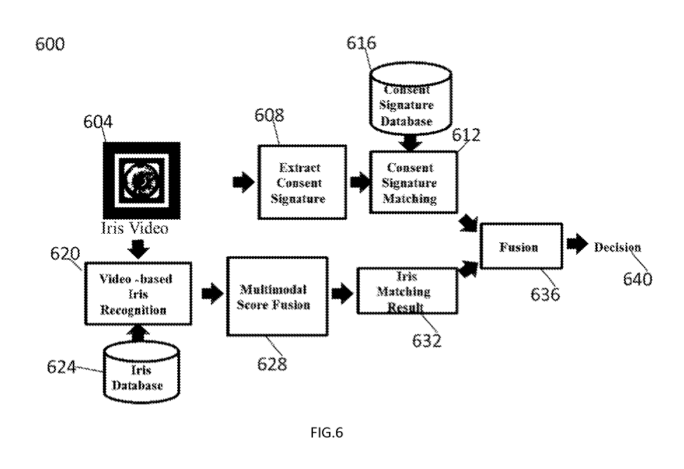

An example authentication design 600 of method 300 using the iris is depicted in FIG. 6. The method begins by acquiring a video sequence of the subject's eye with eye movement (block 604). Imaging of an eye may include illumination of the eye in near infrared, infrared, visible, multispectral, or hyperspectral frequency light. The light may be polarized or non-polarized and the illumination source may be close or remote from the eye. A light source close to an eye refers to a light source that directly illuminates the eye in the presence of the subject. A remote light source refers to a light source that illuminates the eye at a distance that is unlikely to be detected by the subject. As noted below, adjustments may be made to the image to compensate for image deformation that may occur through angled image acquisition or eye movement. Thus, the eye image may be a frontal image or a deformed image. The image acquisition may be performed with a digital video camera having an adequate resolution for imaging features within the iris of the subject's eye. The eye movement sequence is used to test liveness of biometric traits.

The acquired video sequence with dynamic eye movement is processed by a consent signature extraction module (block 608) and a video-based iris recognition module (block 620) respectively. 608 extracts the consent signature from 604. One embodiment of consent signature in this design is a sequence of eye movement, e.g., the eye orientation sequence, including center, left, right, up, up-left and up-right, altogether six directions. It is required that each eye position should be kept for more than certain time to validate the movement state. The corresponding consent signature is bound with each subject's enrolled iris pattern and pre-stored in the consent signature database (616).

Once the consent signature sequence is extracted by 608, it is compared with the one registered in 616 frame by frame (block 612). Only when the distance between the extracted and the registered signature is smaller than a threshold are their orientations considered to be the same. In this way, the extracted signature is verified by 612.

Block 616 continues by segmenting the eye image to isolate the region of the image containing the iris. The segmentation extracts a region of an image containing the pupil at the center with the iris surrounding the pupil. In one embodiment, the pupil acts as the center of the segmented region, with other portions of the iris being described using polar coordinates that locate features using an angle and distance from the center of the pupil. The segmented iris frames are categorized by their orientations, e.g., center, left, right, up, up-left and up-right.

After the iris region is segmented, one or more features presented in the iris image are detected and extracted. The features in question include any unique textures or structural shapes present in the iris region of the eye image. In one embodiment, the stable feature points which are invariant to scale, shift, and rotation are identified in each iris pattern. The sub-regions are distributed in a circular pattern about the pupil, with one partition scheme forming 10 sub-regions in the radial direction, and partitioning the full 360° angle about the pupil into 72 sub-regions for a total of 720 sub-regions. Because a feature might lie on the boundary of a sub-region, the partitioning process in an example embodiment is repeated by offsetting the angle at which partitioning begins by 2.5°. The offsetting ensures that a detected feature will always be included in one of the sub-regions.

For each sub-region, extrema points are selected. These extrema points are the points that are tested to be different from its surrounding neighbors, which could be corner points, edge points and feature points. The block 6 continues by extracting the described iris feature using a bank of two-dimensional Gabor filters. The Gabor wavelet is selected by altering the values of the frequency and standard deviation parameters applied as part of the Gabor filter transformation.

The magnitude response to the 2D Gabor filter of the filtered area is Gaussian weighted based on the spatial distance between each point and the feature point. Specifically, the identified feature points are next described by using a 64-length descriptor that is based on the normalized and Gaussian weighted position of each feature point within a normalized window about the feature point. In one embodiment, the normalized window includes 4 sub-divided bins in the horizontal (x) direction, 4 sub-divided bins in the vertical (y) direction, and 4 subdivided bins corresponding to phase response directions of a 2D Gabor filter of the feature point. If each of the 4 bins is thought of as a dimension, the 4×4×4 matrix forms 64 bins, each one of which holds one of the descriptor values that identifies a feature point.

The generated feature descriptors are then categorized by the eye orientations and matched with the corresponding registered descriptors in the iris database 624. A matching score indicating the similarity between the authenticating iris and the registered one belonging to the identity the subject claims to be is generated for each orientation (block 628). In one embodiment, six match scores are generated by matching the six orientations, center, left, right, up, up-left and up-right respectively.

The example design 600 continues by fusing the multimodal matching scores generated by 628. In one embodiment, five score fusion strategies are applied to 628 and the one with the best accuracy is selected for the 600. The score fused by 628 is then compared to a threshold by block 632 to determine whether the authenticating iris and the registered one are matched. The matching result of 612 and 632 are inputted to a final fusion module (block 632) to determine whether a valid access should be granted. The decision (640) is given by the following rules:
Registered user with right consent signature: the user will be accepted because the right consent signature connecting to his or her identity is matched.
Registered user with wrong consent signature: the user will be rejected since the consent signature generated from consent signature extraction module (608) is unique to each identity and cannot match with the wrong input.
Non-registered user: the user will be rejected in both consent signature matching module (612) and iris matching module (632).

Those skilled in the art will recognize that numerous modifications can be made to the specific implementations described above. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method for detecting whether users are willing to access biometric systems has been developed that includes:
acquiring the signal of a biological, psychological and/or behavior feature (or features) having a biometric feature (or biometric features);
acquiring a dynamic feature (or a series of dynamic features) for a willingness test;
isolating a region of the signal having the biometric feature;
extracting feature information from the region to identify a user;
extracting a user consent signature from the dynamic feature(s) for a willingness test;
storing the biometric feature information and consent signature into a database.

2. The method of claim 1 can be altered to include:
acquiring the signal of biological and/or behavior feature (or features) having a biometric feature (or biometric features);
isolating a region of the signal having the biometric feature;
extracting feature information from the region to identify a user;
extracting a user consent signature from the acquired biometric for willingness test;
storing the of biometric feature information and consent signature into a database.

3. The method of claim 1 can be altered to include:
acquiring a dynamic feature (or a series of dynamic features);
isolating a region of the signal having the biometric feature(s);
extracting feature information from the region to identify a user;
extracting a user consent signature from the dynamic feature(s) for willingness test;
storing the of biometric feature information and willingness signature into a database.

4. The methods of claims 1, 2, and 3, the stored information could be fused biometric feature information and/or a consent signature.

5. The method of claim 1, a biometric feature can be iris, fingerprint, face, hand geometry, palm, retina, skin, ear, ocular, DNA, any other biological, psychological and/or behavior patterns of a person, and any combinations of these biometric features that can be used for human identification/verification.

6. The method of claim 1, a dynamic feature can be eye movement, facial expression, finger movement, any other behavior and/or psychological patterns of a person, and/or any combinations of these patterns that can be extracted for behavior/psychological identification/verification.

7. The method of claim 1, a dynamic feature can also be used to extract a biometric feature.

8. The method of claim 1, a biometric feature can also be used to extract dynamic feature.

9. The method of claim 1, the acquisition method for a biometric feature and/or a dynamic feature can be close (which allows the contact of biometric trait with the sensor), and remote; and can use video, audio, 3D video, multispectral image (video), hyperspectral image (video), magnetic resonance imaging (MRI), X-ray, any other sensing method, and any combinations of these methods that can be used for data acquisition.

10. The method of claim 1, the isolating method can be image segmentation, signal processing, data mining and signal extraction.

11. A method for including a user's willingness into human identification or verification process has been developed that includes:
acquiring the signal of an anatomical feature having a biometric feature (or biometric features);
acquiring a dynamic feature (or a series of dynamic features) for a willingness test;
isolating a region of the signal having the biometric feature;
extracting feature information from the region to identify a user;
extracting a user consent signature from the dynamic feature(s) for a willingness test;
fusing the biometric feature and consent feature for human identification or verification;
storing of the feature information and consent signature into a database.

12. The method of claim 11 can be alternated to include:
acquiring the signal of a biological/behavior feature having a biometric feature (or biometric features);
isolating a region of the signal having the biometric feature;
extracting feature information from the region to identify a user;
extracting a user consent signature from the biometric feature(s);
fusing the biometric feature and willingness feature for human identification or verification;
storing of the feature information and willingness signature into a database.

13. The method of claim 11 can be alternated to include:
acquiring the signal of a dynamic feature (or a series of dynamic features);
isolating a region of the signal having the biometric feature;
extracting feature information from the region to identify a user;
extracting a user consent signature from the dynamic feature(s);
fusing the biometric feature and consent feature for human identification or verification;
storing of the feature information and consent signature into a database.

14. The methods of claims 11, 12, and 13, the stored information could be fused biometric feature information and consent signature.

15. The method of claim 11, a biometric feature can be iris, fingerprint, face, hand geometry, palm, retina, skin, ear, ocular, DNA, any other biological, psychological and/or behavior patterns of a person, and/or any combinations of these features that can be used for human identification/verification.

16. The method of claim 11, a dynamic feature can be eye movement, facial expression, finger movement, any other behavior/psychological patterns of a person, and any combinations of these patterns that can be extracted for behavior identification/verification.

17. The method of claim 11, a dynamic feature can also be used to extract a biometric feature.

18. The method of claim 11, a biometric feature can also be used to extract a dynamic feature.

19. The method of claim 11, the acquiring method for a biometric feature and/or a dynamic feature can be very close (which allows the contact of biometric trait with the sensor), and remote; and can use video, audio, 3D video, multispectral image (video), hyperspectral image (video), magnetic resonance imaging (MRI), X-ray, any other sensing methods, and any combinations of these methods that can be used for data acquisition.

20. The method of claim 11, the isolating method can be image segmentation, signal processing, data mining and signal extraction.

21. The method of claim 11, a fusion method could be feature level, template level, information level fusion and/or combination of these levels.
